(19) United States
(12) Patent Application Publication
(10) Pub. No.: US 2026/0342927 A1
(43) Pub. Date: Oct. 29, 2026

(54) MEDIA DETECTION SENSORS

(71) Applicant: Hewlett-Packard Development Company, L.P., Spring, TX (US)

(72) Inventors: Jeffrey G. Bingham, Vancouver, WA (US); Tyler Phillip Kapp, Vancouver, WA (US)

(21) Appl. No.: 19/116,068

(22) PCT Filed: Sep. 30, 2022
(86) PCT No.: PCT/US2022/045346

§ 371 Date: Mar. 27, 2025

(51) Int. Cl. H04N 1/00

(52) U.S. Cl. CPC H04N 1/00689; H04N 1/00734

(57) ABSTRACT

In some examples, a device can include a media load area having a media load surface, an outer surface adjacent to the media load area, and a sensor included in the device, where the sensor includes a detection area oriented away from the outer surface to detect media located in the media load area that is also at least partially located in the detection area.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1 is a perspective view of an example of a document feeder device consistent with the disclosure.

FIG. 2 is a side-section view of an example of a document feeder device having a media detection sensor including a field of view and a detection area consistent with the disclosure.

FIG. 3 is a side-section view of an example of a document feeder device having a media detection sensor including a field of view and media located outside of the detection area consistent with the disclosure.

FIG. 4 is a side-section view of an example of a document feeder device having a media detection sensor including a field of view and media located partially inside of the detection area consistent with the disclosure.

FIG. 5 is a perspective view of an example of an imaging device having a document feeder device having a media detection sensor consistent with the disclosure.

### DETAILED DESCRIPTION

Imaging devices may include a supply of a print material. As used herein, the term “print material” refers to a substance which can be transported through and/or utilized by an imaging device. In some examples, print material can be, for instance, a material that when applied to a medium, can form representation(s) (e.g., text, images, models, etc.) on the medium during a print job. Print material may include ink, toner, polymers, metals, colorants, etc.

The print material can be deposited onto media, such as a physical medium. As used herein, the term “imaging device” refers to any hardware device with functionalities to physically produce representation(s) (e.g., text, images, models, etc.) on the medium. In some examples, “media” may include paper, photopolymers, plastics, composite, metal, wood, fabric, or the like. An imaging device can further include other functionalities such as scanning, faxing, and/or other imaging device functionalities, and can perform print jobs when in receipt of a print job request from a computing device or other network (e.g., Internet) connected device.

In some examples, a print job may derive from media being processed by an imaging device. For example, as mentioned above, an imaging device may process media by scanning the media via a scanning device associated with the imaging device. As used herein, the term “scanning device” refers to a device that optically scans a media and converts it to a digital image. For example, a scanning device may scan an image on media and convert the image to a digital image.

The imaging device can include a document feeder device that can transport the media from a media load area of the document feeder device to a scanning area of the scanning device. As used herein, the term “document feeder device” refers to a device that feeds media into a scanning area for a print job. For example, a document feeder device can automatically transport a singular page or multiple pages of media to a scanning area of a scanning device for scanning. The document feeder device may utilize rollers, in some examples, to move the media to the scanning area, and then to a media output location of the imaging device.

In some examples, multiple different sizes of media may be fed into a document feeder device and as such, imaging devices can utilize multiple different sizes of media to perform print jobs. To prepare for such print jobs, a document feeder device can detect a size of media to be scanned. Detection of the size of media that is to be scanned can allow for the imaging device to select a particular media size for printing.

In previous approaches, an optical sensor may be physically located in a media load area of the document feeder device in a location underneath the media. Together with mechanical flags, the imaging device could determine a media size of media to be scanned. However, the longer the length of the media, the longer the media load area of the document feeder device had to be in order to detect the media.

As a result of locating an optical sensor in the media load area underneath the media, the size of the document feeder device had to be larger. Such sizing may hinder imaging device geometry overall. For example, it may be desired to design the imaging device geometry with a smaller overall footprint for sizing reasons (e.g., so that the imaging device takes up less space) and/or for aesthetic purposes, which may not be possible given a size of a document feeder device having an optical sensor in the media load area. Further, larger imaging device geometry results in increases in material costs during manufacturing, packaging costs, shipping costs, etc., resulting in a larger overall product cost.

Media detection sensors, according to the disclosure, can allow for a sensor that can be utilized to detect media to be processed by the document feeder device, where the sensor is located outside of a media load area of the document feeder device. Such a sensor placement can allow for a smaller overall footprint for the imaging device, resulting in a lower overall product cost, as well as increased design flexibility, as compared with previous approaches.

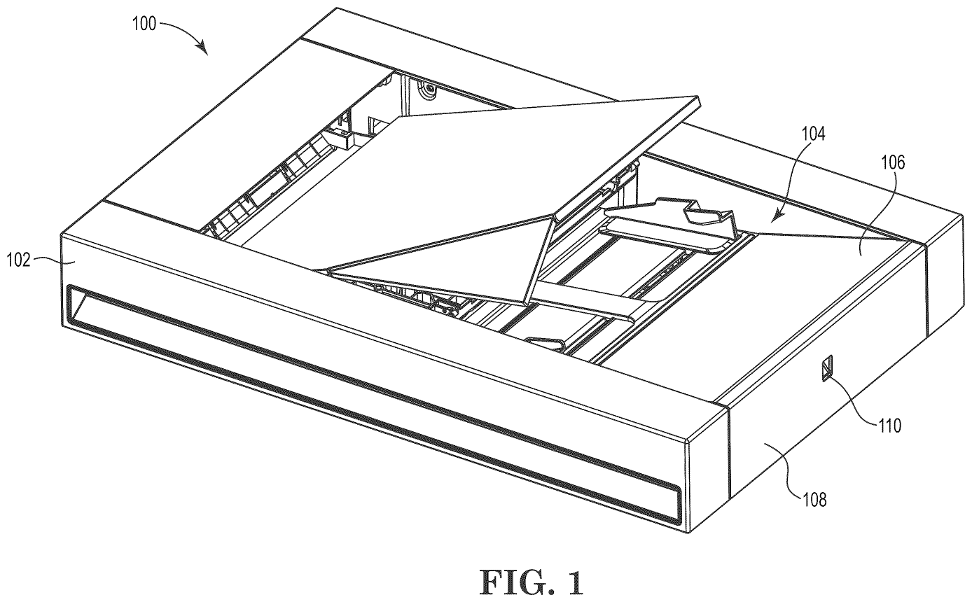

FIG. 1 is a perspective view of an example of a document feeder device 100 consistent with the disclosure. As illustrated in FIG. 1, the document feeder device 100 includes a housing 102, a media load area 104, an outer surface 108, and a sensor 110.

As mentioned above, the document feeder device 100 can transport media from a media load area 104 to a scanning area of a scanning device (e.g., not illustrated in FIG. 1). The document feeder device 100 can transport the media to the scanning area through the housing 102. As used herein, the term “housing” refers to an outer shell of a device. For example, the housing 102 can be an outer shell making up a portion of the document feeder device 100. The housing 102 can include other components of the document feeder device, such as gears, rollers, motors, etc.

As illustrated in FIG. 1, the document feeder device 100 can include the media load area 104. As used herein, the term “media load area” refers to an area of a document feeder device at which media is located prior to being transported by the document feeder device. The media load area 104 can include a media load surface 106. As used herein, the term “media load surface” refers to an outer face of a media load area. Media to be transported by the document feeder device 100 can be placed on the media load surface 106. For example, a single piece of media (e.g., a piece of paper), or multiple pieces of media (e.g., multiple pieces of media, or a media stack) may be placed onto the media load surface 106 in the media load area 104. When ready to be scanned, the document feeder device 100 can transport the media from the media load area 104 to the scanner device for scanning.

The housing 102 can include an outer surface 108. The outer surface 108 can be located adjacent to the media load surface 106 of the media load area 104.

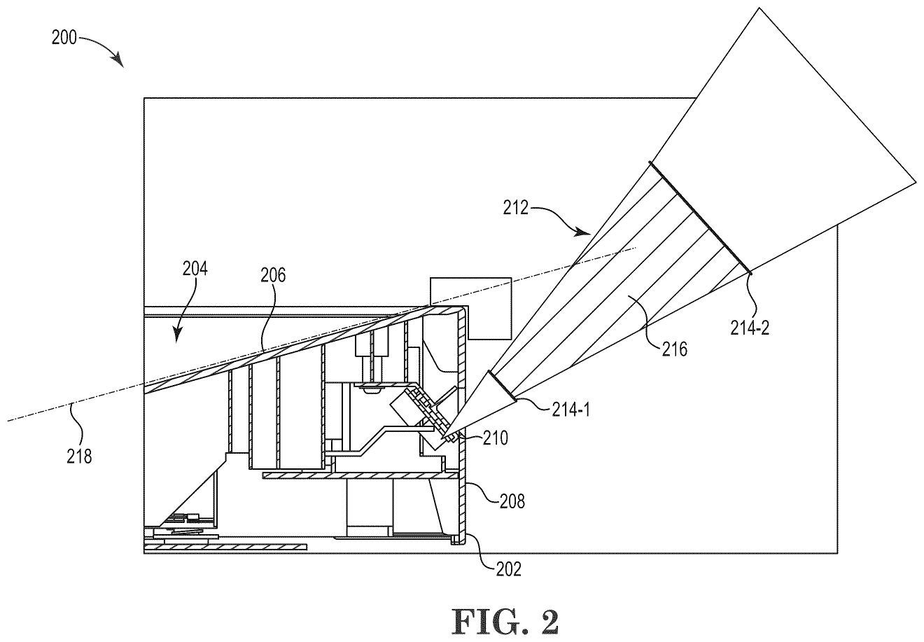

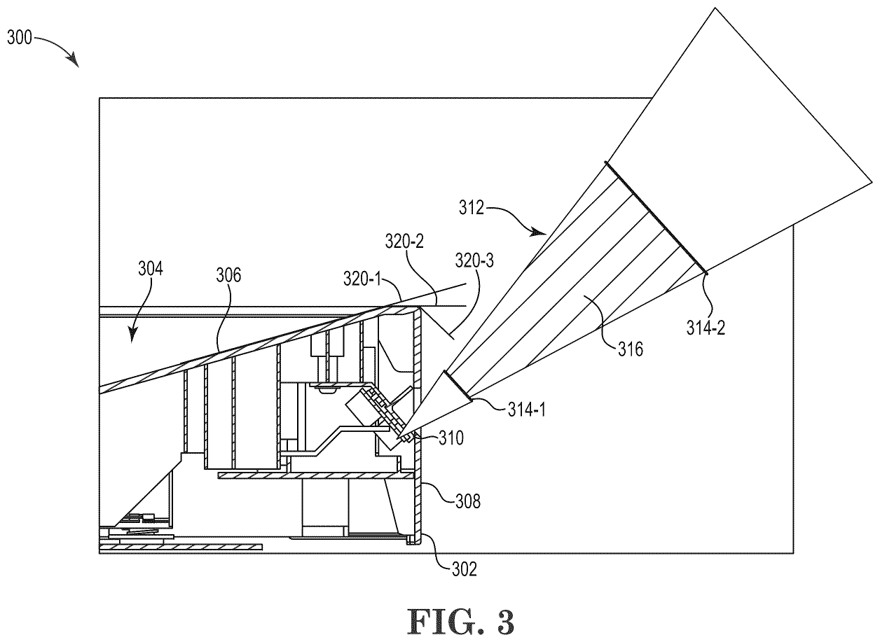

In order to detect a size of media to be transported by the document feeder device 100, the document feeder device 100 can include a sensor 110 in the housing 102. As used herein, the term “sensor” refers to a device to detect events and/or changes in its environment and transmit the detected events and/or changes for processing and/or analysis. For example, the sensor 110 can detect the presence of media and transmit a signal that the media of a certain size is detected to a controller (e.g., not illustrated in FIG. 1) for processing and/or analysis. An imaging device can utilize the signal in preparation for a print job, as is further described in connection with FIGS. 3-5. The sensor 110 can be oriented in the housing 102 such that a field of view of the sensor 110 is oriented away from the outer surface 108 and a detection area is defined within the field of view to detect media being at least partially located on the media load surface 106 and at least partially located in the detection area, as is further described in connection with FIG. 2.

FIG. 2 is a side-section view of an example of a document feeder device 200 having a media detection sensor 210 including a field of view 212 and a detection area 216 consistent with the disclosure. The document feeder device 200 can further include a housing 202 having the media load area 204 including a media load surface 206, and an outer surface 208.

As previously described in connection with FIG. 1, the document feeder device 200 can include a sensor 210. The sensor 210 can include a field of view 212. As used herein, the term “field of view” refers to an observable area seen by a device. For example, the field of view 212 is an area in which the sensor 210 can detect media that may be placed on the media load surface 206 in the media load area 204.

In some examples, the sensor 210 can be a Time-of-Flight sensor. As used herein, the term “Time-of-Flight sensor” refers to a device which employs time-of-flight techniques to detect an object within a field of view and a distance of the object from the device using an artificial light signal. For example, the sensor 210 can utilize time-of-flight techniques to detect media located in a particular area of the field of view 212 of the sensor 210, as is further described herein.

Utilizing a Time-of-Flight sensor can allow for higher detection accuracy as compared with traditional optical sensors located in the media load area 204. For example, a Time-of-Flight sensor can accurately detect objects within a detection area while receiving a lower amount of detected photons (e.g., from the light signal emitted by the Time-of-Flight sensor) as compared to other optical sensors. Further, such a Time-of-Flight sensor can enable accurate detection of media having different reflectivity levels. Since media located in the media load area 204 can include different reflectivity levels (e.g., due to the type of media (printer paper, photographic paper, etc.) as well as any image located on the media), the Time-of-Flight sensor can accurately detect such media when it is at least partially located in the detection area 216.

While the sensor 210 is described above as being a Time-of-Flight sensor, examples of the disclosure are not so limited. In some examples, the sensor 210 could be an optical sensor. In some examples, the sensor 210 could be an ultrasonic sensor. In other words, the sensor 210 can be any sensor that can be utilized to determine a distance and/or a proximity with an object.

As mentioned above, a detection area 216 can be defined within the field of view 212. As used herein, the term “detection area” refers to a region in which an object is detectable. The detection area 216 can be defined within the field of view 212 by a first bounding line 214-1 and a second bounding line 214-2. For example, the sensor 210 (e.g., the Time-of-Flight sensor) can utilize a predetermined first time of flight to set a first distance from the sensor 210 for the first bounding line 214-1 and a second predetermined time of flight to set a second distance from the sensor 210 for the second bounding line 214-2. Accordingly, an object (e.g., media) can be detected that has some portion that is located between the bounding lines 214-1 and 214-2 (e.g., within the detection area 216) by a light signal having a time of flight that lies between the first time of flight and the second time of flight defining the bounding lines 214-1 and 214-2, respectively. In other words, the sensor 210 can utilize the timing of light signals transmitted/emitted by the sensor 210 (e.g., and reflected by an object located in the detection area 216) to determine that an object is located in the detection area 216 based on the return light signal reflected off of the object having a timing that lies between the first predetermined time of flight (e.g., defining the first bounding line 214-1) and the second predetermined time of flight (e.g., defining the second bounding line 214-2).

Although the detection area 216 is described above as being defined by two bounding lines 214-1 and 214-2, examples of the disclosure are not so limited. For instance, in one example, the detection area 216 can be defined by the single first bounding line 214-1 (but not the second bounding line 214-2) such that an object can be detected that has some portion that is located in the field of view 212 but beyond the bounding line 214-1 (e.g., in the field of view beyond the bounding line 214-1 in a direction away from the surface 208). In another example, the detection area 216 can be defined by the single second bounding line 214-2 such that an object can be detected that has some portion that is located in the field of view 212 but is located before the bounding line 214-2 (e.g., in the field of view between the surface 208 and the second bounding line 214-2).

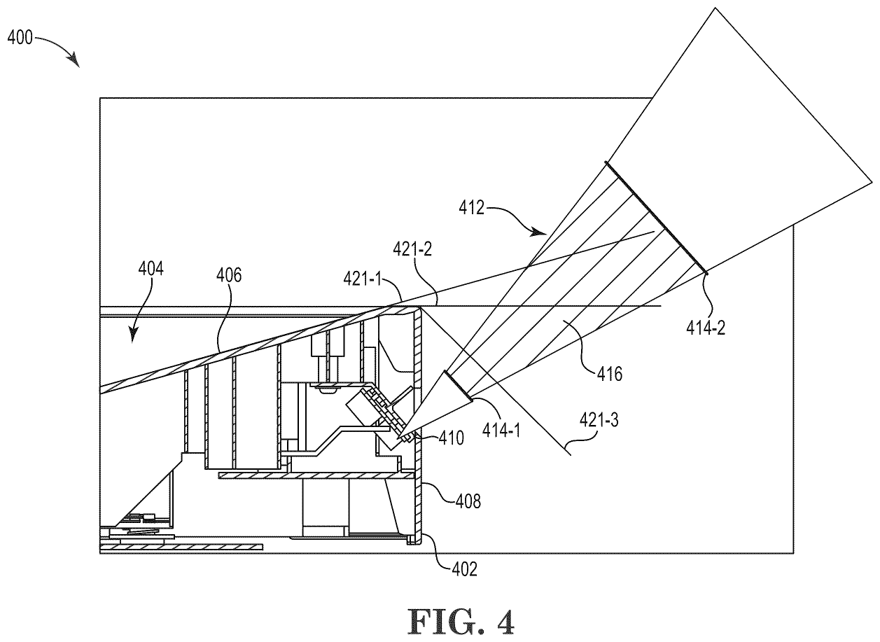

Accordingly, the sensor 210 can be utilized to detect media in response to media being at least partially located in the detection area 216 between the first bounding line 214-1 and the second bounding line 214-2. That is, the sensor 210 can detect a media having a particular length that is at least partially located (e.g., resting on) the media load surface 206 and at least partially located in the media detection area 216, as is further described in connection with FIG. 4.

As illustrated in FIG. 2, the sensor 210 is oriented in the housing 202 such that the detection area 216 of the sensor 210 is oriented away from the outer surface 208 and outside of the media load area 204. Accordingly, the sensor 210 and the field of view 212 of the sensor 210 is located outside of the media load area 204. For example, the media load surface 206 can define a plane 218. The plane 218 can be a flat, two-dimensional surface that extends indefinitely from the media load surface 206. The field of view 212 of the sensor 210 intersects the plane 218 outside of the media load surface 206. Accordingly, the sensor 210 can detect media partially located on the media load surface 206 that also extends off the media load surface 206 (e.g., has a particular length) and is also partially located in the detection area 216, as is further described in connection with FIG. 4. Utilizing such an approach, the sensor 210 can be located outside of the media load area 204 while detecting media partially located on the media load surface 206 and partially located in the detection area 216 of the sensor 210.

FIG. 3 is a side-section view of an example of a document feeder device 300 having a media detection sensor 310 including a field of view 312 and media 320 located outside of the detection area 316 consistent with the disclosure. The document feeder device 300 can further include a housing 302 having the media load area 304 including a media load surface 306, and an outer surface 308.

As illustrated in FIG. 3, the document feeder device 300 can include media 320. The media 320 can come in different forms. For example, media 320-1 may be a rigid media that remains substantially straight when placed on the media load surface 306 of the media load area 304. The media 320-2 may be a less rigid media than media 320-1, as media 320-2 is partially bent (e.g., due to gravity) when placed on the media load surface 306 of the media load area 304. The media 320-3 may be the least rigid and most flexible media (e.g., as compared to media 320-2 and media 320-1) as it is folded over an edge and hanging down towards the outer surface 308 (e.g., due to gravity) when placed on the media load surface 306 of the media load area 304.

Accordingly, whatever rigidity of media 320 is placed on the media load surface 306 of the media load area 304, as illustrated in FIG. 3, the media 320 is not long enough to extend into and be partially located in the detection area 316 of the sensor 310. That is, the media 320 is at least partially located on the media load surface 306 (e.g., a portion of the length of the media 320 is located on the media load surface 306), but the sensor 310 does not detect the media 320 being at least partially located in the detection area 316. Accordingly, a controller (e.g., not illustrated in FIG. 3) can determine the media type of the media 320 to be a short-format media type. For example, short-format media types can include sizes including A, A4, A5, A6, etc., although examples of the disclosure are not limited to such media types.

Based on the determined media type, an imaging device (e.g., not illustrated in FIG. 3) can perform a print job. For example, based on the media type being determined to be a short-format media type, the imaging device can perform a print job utilizing a similar or same short-format media type by selecting a particular tray having short-format media and printing on the short-format media from the selected tray. Such an approach can allow for faster processing and performance of print jobs, as the media type can be determined prior to scanning operations.

FIG. 4 is a side-section view of an example of a document feeder device 400 having a media detection sensor 410 including a field of view 412 and media 421 located partially inside of the detection area 416 consistent with the disclosure. The document feeder device 400 can further include a housing 402 having the media load area 404 including a media load surface 406, and an outer surface 408.

As illustrated in FIG. 4, the document feeder device 400 can include media 421. The media 421 can come in different forms. For example, media 421-1 may be a rigid media that remains substantially straight when placed on the media load surface 406 of the media load area 404. The media 421-2 may be a less rigid media than media 421-1, as media 421-2 is partially bent (e.g., due to gravity) when placed on the media load surface 406 of the media load area 404. The media 421-3 may be the least rigid and most flexible media (e.g., as compared to media 421-2 and media 421-1) as it is folded over an edge and hanging down towards the outer surface 408 (e.g., due to gravity) when placed on the media load surface 406 of the media load area 404.

Accordingly, whatever rigidity of media 421 is placed on the media load surface 406 of the media load area 404, as illustrated in FIG. 4, the media 421 extends into and is partially located in the detection area 416 of the sensor 410. That is, the media 421 is at least partially located on the media load surface 406 (e.g., a portion of the length of the media 421 is located on the media load surface 306), and the sensor 410 detects the media 421 being at least partially located in the detection area 416. Accordingly, a controller (e.g., not illustrated in FIG. 4) can determine the media type of the media 421 to be a long-format media type. For example, long-format media types can include media sizes such as Legal, Government-Legal, F4, etc., although examples of the disclosure are not limited to such media types.

Based on the determined media type, an imaging device (e.g., not illustrated in FIG. 4) can perform a print job. For example, based on the media type being determined to be a long-format media type, the imaging device can perform a print job utilizing a similar or same long-format media type by selecting a particular tray having long-format media and printing on the long-format media from the selected tray. Such an approach can allow for faster processing and performance of print jobs, as the media type can be determined prior to scanning operations.

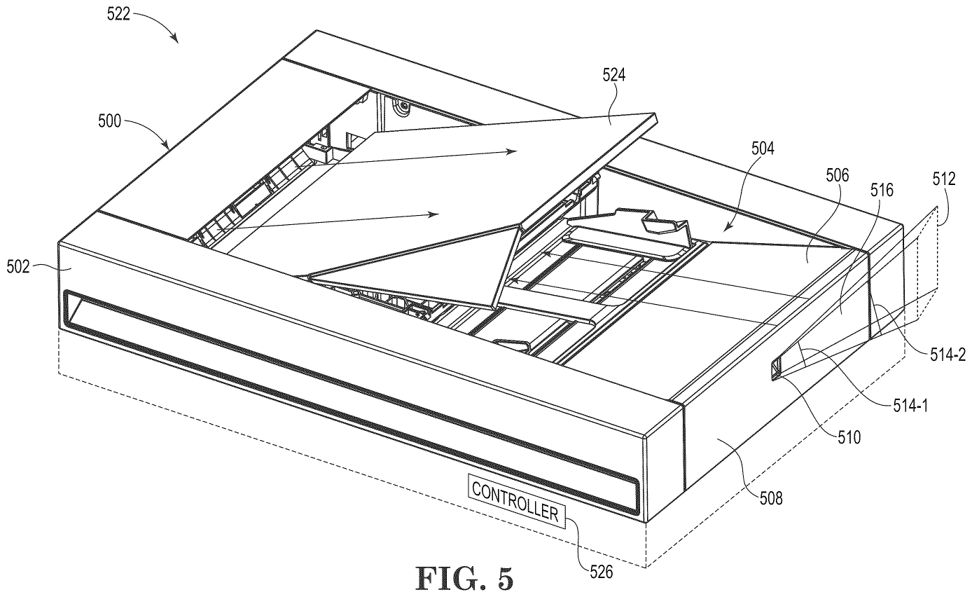

FIG. 5 is a perspective view of an example of an imaging device 522 having a document feeder device 500 having a media detection sensor 510 consistent with the disclosure. As illustrated in FIG. 5, the imaging device can further include a controller 526.

As illustrated in FIG. 5, the imaging device 522 can include a document feeder device 500. The document feeder device 500 can include a media load area 504 having a media load surface 506. As indicated by the arrows in the media load area 504, media placed on the media load surface can be transported by the document feeder device 500 to a scanner device. Once finished at the scanner device, the document feeder device 500 can transport the media from the scanner device to a media output tray 524, as indicated by the arrows on the media output tray 524, as is further described herein.

The document feeder device 500 can further include the outer surface 508 adjacent to the media load surface 506 and the sensor 510. As previously described herein, the sensor 510 can be a Time-of-Flight sensor and can be oriented in the document feeder device 500 such that the field of view 512 of the sensor 510 is oriented away from the outer surface 508. Additionally, a detection area 516 can be defined within the field of view 512 to detect media being at least partially located on the media load surface 506 and at least partially located in the detection area 516. The detection area 516 can be defined by bounding lines 514-1 and 514-2.

The imaging device 522 can further include a controller 526. Although not illustrated in FIG. 5, the controller 526 can include a processor and a non-transitory machine-readable storage medium. The processor can be a processing resource such as a central processing unit (CPU), microprocessor, and/or other hardware device suitable for retrieval and execution of instructions stored in a non-transitory machine-readable storage medium (e.g., not illustrated in FIG. 5). As an alternative or in addition to retrieving and executing instructions, the processing resource may include an electronic circuit comprising a number of electronic components for performing the operations of the instructions in the non-transitory machine-readable storage medium.

The non-transitory machine-readable storage medium may be any electronic, magnetic, optical, or other physical storage device that stores executable instructions. Thus, the non-transitory machine-readable storage medium may be, for example, Random Access Memory (RAM), an Electrically-Erasable Programmable Read-Only Memory (EEPROM), a storage drive, an optical disc, and the like. The executable instructions may be “installed” in the non-transitory machine-readable storage medium. The non-transitory machine-readable storage medium may be a portable, external or remote storage medium, for example, that allows the computing device 640 to download the instructions from the portable/external/remote storage medium. In this situation, the executable instructions may be part of an “installation package”.

The controller 526 can utilize the processor and the non-transitory machine-readable storage medium to determine a media type of the media based on whether the media is at least partially located on the media load surface 506 and at least partially located in the detection area 516. For example, as previously described in connection with FIG. 3, media may be placed on the media load surface 506 that is not long enough to extend into and be partially located in the detection area 516 of the sensor 510. Accordingly, while the media may be partially located on the media load surface 506, the sensor 510 does not detect the media being at least partially located in the detection area 516, and the controller 526 can determine the media to be a short-format media type. For example, the imaging device 522 can perform a print job based on the short-format media type utilizing a similar or same short-format media type by selecting a particular tray having a same or similar short-format media and printing on the media from the selected tray.

As another example, as previously described in connection with FIG. 4, media may be placed on the media load surface 506 that is long enough to extend into and be partially located in the detection area 516 of the sensor 510. Accordingly, the media may be partially located on the media load surface 506, and the sensor 510 detects the media being at least partially located in the detection area 516. The controller 526 can determine the media to be a long-format media type. For example, the imaging device 522 can perform a print job based on the long-format media type utilizing a similar or same long-format media type by selecting a particular tray having a same or similar long-format media and printing on the media from the selected tray.

As mentioned above, the document feeder device 500 further comprises the media output tray 524. As used herein, the term “media output tray” refers to a receptacle in which media is collected following processing in an imaging device. For example, once the media is processed through the housing 502 via the media load area 504, the media can be ejected from the housing 502 to the media output tray 524. Such processing may include being scanned by a scanning device (e.g., not illustrated in FIG. 5) of the imaging device 522. Accordingly, the media may be placed on the media load surface 506 of the media load area, the controller 526 can determine the media type of the media based on whether the sensor 510 detects the media, the media can be processed through the housing 502, and ejected to the media output tray 524.

Although the print jobs as described above by the imaging device 522 include printing a copied image from media placed in the media load area 504, examples of the disclosure are not so limited. In some examples, the controller 526 can determine the media type of media placed in the media load area 504 and based on the determined media type, the controller 526 can determine a scan length of the media. As used herein, the term “scan length” refers to an amount of time a scanning device performs a scan operation. For example, a scan length of a short-format media can be a shorter amount of time than a scan length of a long-format media. Based on the determined media type, the controller 526 can determine a scan length corresponding to the short-format media (e.g., a shorter scan length than long-format media) or to the long-format media (e.g., a longer scan length than short-format media). Such an approach can allow for faster processing and performance of print jobs.

In some examples, the controller 526 can determine the media type of media placed in the media load area 504 and based on the determined media type, can determine whether a media path jam of the imaging device has occurred. As used herein, the term “media path jam” refers to media that is stuck in a media path of an imaging device and cannot automatically eject. The controller 526 can cause media path sensors in the document feeder device 500 (e.g., not illustrated in FIG. 5) to toggle at certain times based on the determined media type. For example, the controller 526 can cause a media path sensor in the document feeder device 500 to toggle at a first time based on the media type being a short-format media type and the media path sensor to toggle at a second time based on the media type being a long-format media type, where the first time is earlier than the second time. For instance, the media may move through the document feeder device 500 at ten inches per second. At such a rate, it may take a short-format media type 1.1 seconds to pass by the media path sensor, where it may take a long-format media type 1.4 seconds to pass by the media path sensor. Accordingly, the controller 526 can generate an error if a leading edge of the media triggers the media path sensor but the media does not clear the sensor within a first threshold amount of time (e.g., 1.1 seconds) for a short-format media type or within a second threshold of time (e.g., 1.4 seconds) for a long-format media type.

Media detection sensors according to the disclosure can allow for a sensor located outside of a media load area of a document feeder device to detect media for determination of a media type. Placement of the sensor outside of the media load area can allow for a smaller overall footprint for the imaging device, which can allow for aesthetically pleasing designs while lowering overall product costs. Additionally, use of a Time-of-Flight sensor can allow for more reliable detection of different types of media, as compared with previous approaches.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A device, comprising:
a media load area having a media load surface;
an outer surface adjacent to the media load area; and
a sensor included in the device, wherein the sensor includes a detection area oriented away from the outer surface to detect media located in the media load area that is also at least partially located in the detection area.

2. The device of claim 1, wherein the sensor includes a field of view.

3. The device of claim 2, wherein the detection area is defined within the field of view by a first bounding line and a second bounding line.

4. The device of claim 3, wherein the sensor is to detect the media in response to the media being at least partially located in the detection area between the first bounding line and the second bounding line.

5. The device of claim 1, wherein the sensor is to detect the media in response to the media being at least partially located on the media load surface and at least partially located in the detection area.

6. The device of claim 1, wherein the sensor is a Time-of-Flight sensor.

7. A document feeder device, comprising:
a housing;
a media load area in the housing having a media load surface;
an outer surface of the housing adjacent to the media load area; and
a sensor included in the housing, wherein:
the sensor is oriented in the housing such that a field of view of the sensor is oriented away from the outer surface; and
a detection area is defined within the field of view to detect media being at least partially located on the media load surface and at least partially located in the detection area.

8. The document feeder device of claim 7, wherein the media load surface defines a plane.

9. The document feeder device of claim 8, wherein the field of view of the sensor intersects the plane outside of the media load surface.

10. The document feeder device of claim 7, wherein:
the document feeder device further comprises a media output tray connected to the housing; and
the media is processed through the housing via the media load area and ejected to the media output tray.

11. An imaging device, comprising:
a document feeder device comprising:
a media load area having a media load surface;
an outer surface adjacent to the media load surface; and
a sensor, wherein:
the sensor is oriented in the document feeder device such that a field of view of the sensor is oriented away from the outer surface; and
a detection area is defined within the field of view to detect media being at least partially located on the media load surface and at least partially located in the detection area; and
a controller to determine a media type of the media based on whether the media is at least partially located on the media load surface and at least partially located in the detection area.

12. The imaging device of claim 11, wherein the imaging device is to perform a print job based on the media type.

13. The imaging device of claim 12, wherein:
in response to the sensor detecting the media being at least partially located in the detection area and the media being at least partially located on the media load surface, the controller is to determine the media type to be a long-format media type; and
the imaging device is to perform the print job based on the long-format media type.

14. The imaging device of claim 12, wherein:
in response to the media being at least partially located on the media load surface but the sensor not detecting the media being at least partially located in the detection area, the controller is to determine the media type to be a short-format media type; and
the imaging device is to perform the print job based on the short-format media type.

15. The imaging device of claim 12, wherein the imaging device is to at least one of:
determine a scan length based on the media type; and
determine a media path jam of the imaging device.
